(19) United States
(12) Patent Application Publication
(10) Pub. No.: US 2023/0343331 A1
(43) Pub. Date: Oct. 26, 2023

(54) METHODS AND APPARATUS TO CONTROLLABLE MULTIMODAL MEETING SUMMARIZATION WITH SEMANTIC ENTITIES AUGMENTATION

(71) Applicants: Ramesh Radhakrishna Manuvinakurike, Hillsboro, OR (US); Saurav Sahay, Santa Clara, CA (US); Sangeeta Ghangam Manepalli, Chandler, AZ (US); Sumanta Bhattacharyya, Chicago, IL (US); Sahisnu Mazumder, San Francisco, CA (US); Cagri Cagatay Tanriover, Portland, OR (US)

(72) Inventors: Ramesh Radhakrishna Manuvinakurike, Hillsboro, OR (US); Saurav Sahay, Santa Clara, CA (US); Sangeeta Ghangam Manepalli, Chandler, AZ (US); Sumanta Bhattacharyya, Chicago, IL (US); Sahisnu Mazumder, San Francisco, CA (US); Cagri Cagatay Tanriover, Portland, OR (US)

(21) Appl. No.: 18/342,705

(22) Filed: Jun. 27, 2023

Related U.S. Application Data
(60) Provisional application No. 63/484,743, filed on Feb. 13, 2023.

(51) Int. Cl. G10L 15/183; G10L 15/18; G10L 15/22; G10L 15/06

(52) U.S. Cl. CPC G10L 15/183; G10L 15/1815; G10L 15/22; G10L 15/063; G10L 2015/088

(57) ABSTRACT

Disclosed is a technical solution to summarize a multimodal conferencing environment. The solution is designed to improve efficiency and accuracy of computing systems as a summarization tool by incorporating memory, machine readable instructions, and processor circuitry. The solution executes the functions of adjusting a language model based on a terminology utilized in a first context data; generating a conversation summary from a transcription and a human controlled variable; extracting a semantic entity from the conversation summary and second context data, where the second context data is indicative of an input associated with a conferencing environment; and summarize the semantic entity and the second context data using the adjusted language model.

### RELATED APPLICATION

This patent claims the benefit of U.S. Provisional Patent Application No. 63/484,743, which was filed on Feb. 13, 2023, and is incorporated by reference in its entirety.

### FIELD OF THE DISCLOSURE

This disclosure relates generally to machine learning and, more particularly, to methods and apparatus to controllable multimodal meeting summarization with semantic entities augmentation.

### BACKGROUND

Conferencing and meetings have become integrated as communication methods in modern society as a means of achieving personal and professional alignment, discussion, or entertainment. With the development of technology, teleconferencing and videoconferencing have become commonplace to allow for more accessibility for users to meet. Tools have been developed for the advancement of accessibility, such as auto-captioning and post-meeting summary generation. For example, machine learning systems may analyze audio of a media to convert speech detected in the audio into a transcribed text of the meeting. Later, after the meeting has ended, a user may generate a summary of the meeting that conveys the gist of the meeting in fewer words than the full transcription. For example, the summary may report important details, reminders, dates, etc. that are conveyed during the meeting without providing an extensive word-for-word listing of the meeting speech.

In recent years, there has been a momentum in the computing industry to deploy artificial intelligence, and more specifically machine learning models as tools to perform tasks for user-convenience. Artificial intelligence models assist with auto-fill solutions, offline automatic note generation, post-meeting automatic note generation, etc.

### BRIEF DESCRIPTION OF THE DRAWINGS

FIG. 1A is a block diagram of an example environment in which an example extractive summarization circuitry, domain adaptation circuitry, semantic entity extraction circuitry, and abstractive summarization circuitry operates to train a model to summarize multimodal meeting input.

FIG. 1B is a block diagram of an example environment in which an example extractive summarization circuitry, semantic entity extraction circuitry, and abstractive summarization circuitry operates to apply a model to summarize multimodal meeting input.

FIG. 2 is a block diagram of an example implementation of the extractive summarization circuitry 110 of FIG. 1.

FIG. 3 is a block diagram of an example implementation of the domain adaptation circuitry 116 of FIG. 1.

FIG. 4 is a block diagram of an example implementation of the semantic entity extraction circuitry 120 of FIG. 1.

FIG. 5 is a block diagram of an example implementation of the abstractive summarization circuitry 125 of FIG. 1.

FIG. 6 is a block diagram of an example implementation of the semantic entity extraction circuitry 120 of FIG. 1.

FIG. 7A is a block diagram of an example encoder-decoder architecture of the abstractive summarization circuitry 125 of FIG. 1.

FIG. 7B is a block diagram of an example decoder only implementation architecture of the abstractive summarization circuitry 125 of FIG. 1.

FIG. 8 is a flowchart representative of example machine readable instructions and/or example operations that may be executed, instantiated, and/or performed by example programmable circuitry to implement the extractive summarization circuitry of FIG. 1A.

FIG. 9 is a flowchart representative of example machine readable instructions and/or example operations that may be executed, instantiated, and/or performed by example programmable circuitry to implement the semantic entity extraction circuitry of FIG. 1A.

FIG. 10 is a flowchart representative of example machine readable instructions and/or example operations that may be executed, instantiated, and/or performed by example programmable circuitry to implement the domain adaptation circuitry of FIG. 1A.

FIG. 11 is a flowchart representative of example machine readable instructions and/or example operations that may be executed, instantiated, and/or performed by example programmable circuitry to implement the abstractive summarization circuitry of FIG. 1A.

FIG. 12A is an example workflow of multimodal data processing performed by the extractive summarization circuitry 110 of FIGS. 1A and 1B.

FIG. 12B is a demonstrative workflow of the semantic entity extraction circuitry of FIGS. 1A and 1B.

FIG. 12C is a video stream processing block diagram for the extractive summarization circuitry 110 of FIGS. 1A and 1B.

FIG. 13 is a user workflow flowchart demonstrating how to use the extractive summarization circuitry, semantic entity extraction circuitry, and abstractive summarization circuitry to apply a model to summarize multimodal meeting input.

FIG. 14 is a high-level system workflow diagram demonstrating how the extractive summarization circuitry, semantic entity extraction circuitry, and abstractive summarization circuitry take multimodal data, apply a model to summarize multimodal meeting input, and output highlights and metadata.

FIG. 15 is a block diagram of an example processing platform including programmable circuitry structured to execute, instantiate, and/or perform the example machine readable instructions and/or perform the example operations of FIGS. 8-11 to implement the extractive summarization circuitry, semantic entity extraction circuitry, and abstractive summarization circuitry of FIG. 1A.

FIG. 16 is a block diagram of an example implementation of the programmable circuitry of FIG. 15.

FIG. 17 is a block diagram of another example implementation of the programmable circuitry of FIG. 15.

FIG. 18 is a block diagram of an example software/firmware/instructions distribution platform (e.g., one or more servers) to distribute software, instructions, and/or firmware (e.g., corresponding to the example machine readable instructions of FIGS. 8-11) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Example disclosed here utilize machine learning analysis to generate a summary of a media that is based on analysis of the transcription of the media as well as context related to the meeting. Examples disclosed herein utilize machine learning analysis to adjust a pre-existing language model based on terminology utilized in a context such as a geographical region, a similar interest or hobby, company-specific terms, etc. For example, in some instances, the example disclosed herein may be utilized to analyze spoken language during a meeting, phone call, teleconference, video conference, person-to-person interaction, etc. For example, by incorporating context information, a more accurate transcription may be generated.

Examples disclosed herein utilize machine learning analysis to generate an extractive conversation summary, where an extractive summarization model determines the importance of utterances in a conversation and summarizes the conversation using a verbatim subset of the utterances, from a transcription and human controlled variables such as a time start, a time end, a user to focus on, words or phrases to focus on, etc. Examples disclosed herein utilize machine learning analysis to generate semantic entities from a video input extraction and contextual data associated with a conferencing environment, past highlights, keywords, previous notes, etc. Examples disclosed herein utilize machine learning analysis, specifically an abstractive summarization model, to generate abstractive summaries, where natural language techniques are used to create a more human-friendly summary of the content of a conferencing environment using an adjusted language model, extracted semantic entities, and human controlled variables.

In examples disclosed herein, ML/AI models are trained using self-supervised learning where the model is fed with unlabeled data and the model generates data labels automatically. However, any other training algorithm may additionally or alternatively be used. In examples disclosed herein, training is performed until a domain-specific language model is developed. In examples disclosed herein, training is performed at a central facility. Training is performed using hyperparameters that control how the learning is performed (e.g., a learning rate, a number of layers to be used in the machine learning model, etc.). In examples disclosed herein, hyperparameters that control training parameters and semantic entity extraction are used, such as the number of layers, hidden size, dropout rate, learning rate, and batch size. The models disclosed herein have the training hyperparameters as indicated by base models, such as BART large, CLIP, and BERT-base, for example. Such hyperparameters are selected by, for example, experimentation. The experimentation indicates that a larger batch size results in better model performance for visual entity extraction.

Training is performed using training data. In examples disclosed herein, the training data originates from locally generated domain-specific unlabeled data. Because the training is a self-supervised process of making the models re-learn representations, better domain-specific embeddings are achieved.

Once training is complete, the model is deployed for use as an executable construct that processes an input and provides an output based on the network of nodes and connections defined in the model. An example model is stored in example data storage 504 of FIG. 5. The model may then be executed by the abstractive summarization circuitry.

Real-time note taking during meeting is a challenging task. While transcription has become commonplace, summarizing the meeting minutes in a way that captures the gist of the meeting with additional details is largely a post-meeting manual task today. Current note-taking systems often lack real-time incremental capabilities, where notes generation often happens post-meeting where the models consume the transcriptions and generate notes after the meeting has concluded. Additionally, there is a lack of controllability in the notes generation, limited model capacity, and a lack of multimodality in the inputs. Furthermore, current approaches rely on the existence of training data for new language domains. The approach disclosed herein generates meeting summaries and performs notetaking while solving the aforementioned problems.

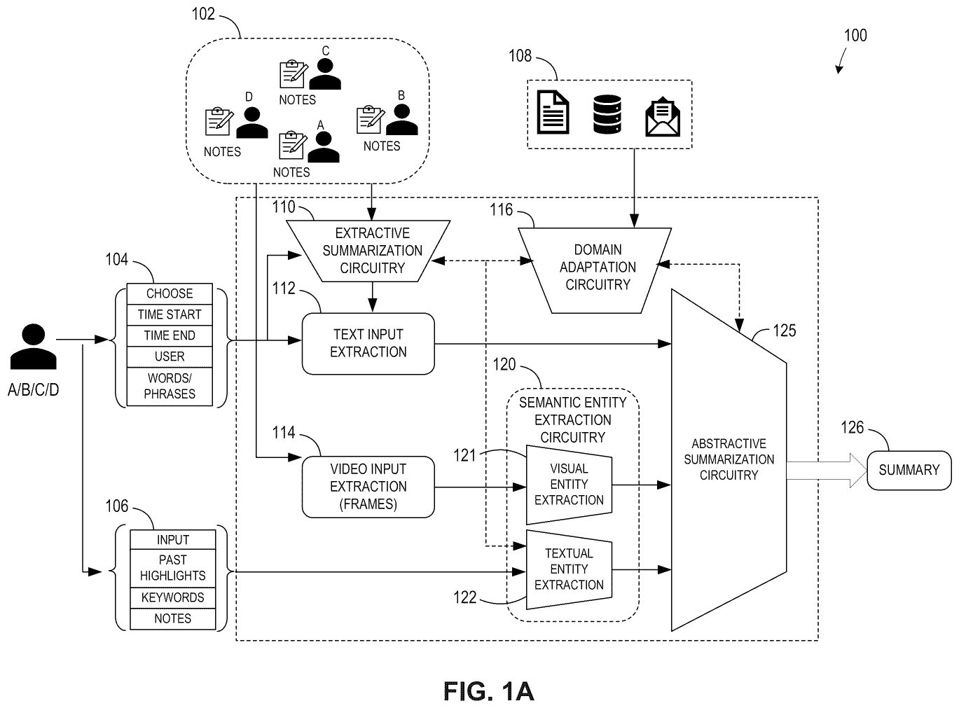

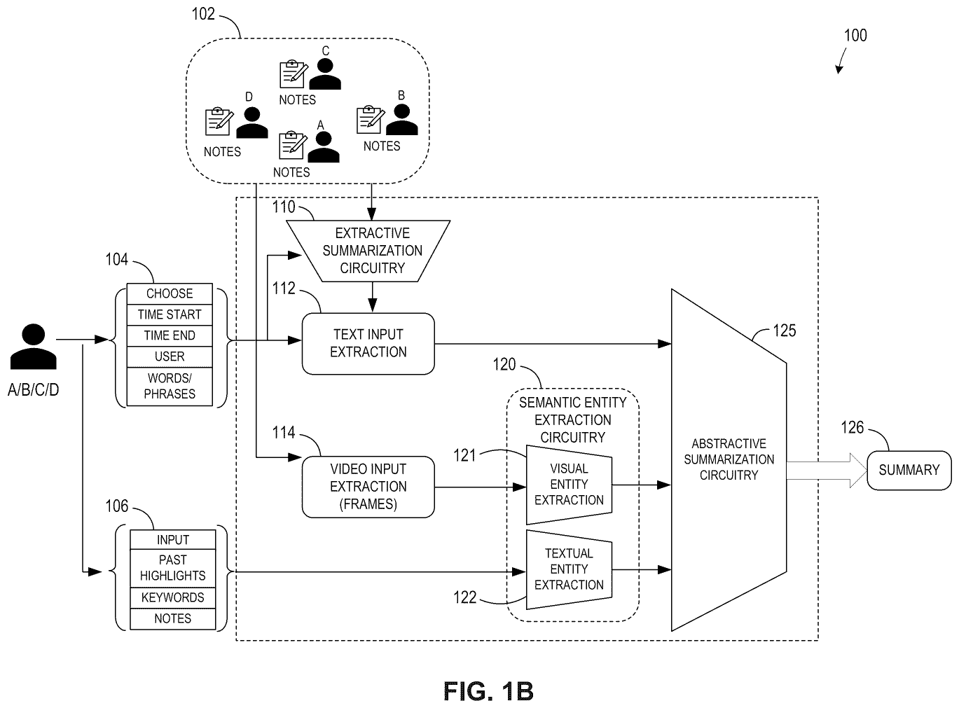

FIG. 1A is a block diagram of an example environment in which an example controllable multimodal meeting summarization system 100 operates in the training phase of machine learning. The example controllable multimodal meeting summarization system 100 trains models to take multimodal input, historical data, and instructions from a user, and then output a summary specific to a language domain.

The example controllable multimodal meeting summarization system 100 performs model training by feeding unlabeled data representative of domain-specific terminology used in a context 108 into the example domain adaptation circuitry 116. The domain adaptation circuitry 116 uses this input data and a pre-existing language model stored within data storage 304 within the domain adaptation circuitry 116 to adjust the pre-existing language model to be specific to a context or domain (e.g. a listing of company specific abbreviations). The input data is copied and the copy is altered in order to create new data points, a process referred to as data augmentation. Additionally, noise injection is performed, where the input data is copied and noise is added to the copied data. The adjustment of the language model is performed by retraining the language model after using noise injection and data augmentation on the initial context or domain to re-learn representations of the language model. The adjusted language model is integrated into the abstractive summarization model of the abstractive summarization circuitry 125 by communicating the re-learned representations of the language model so that the abstractive summarization model can synthesize extracted semantic entities and an extractive summary of a conferencing environment with greater fidelity.

When example conferencing environment 102 of FIG. 1A commences the system 100 takes notes on each user, users A, B, C, and D. The automatically generated notes are sent to the example extractive summarization circuitry 110 for training the extractive summarization model.

The auto-generated notes of the conferencing environment 102 are also subject to video input extraction processing logic 114 to use as input to semantic entity extraction circuitry 120. The video extraction processing logic executes an incremental extraction, where a video stream and screen content are received. The video stream and screen content are encoded, then monitored for changes. From the changes monitored, a video clip, chat, or summary trigger metadata are generated as extracted frames. Within the semantic entity extraction circuitry 120, the extracted frames are input to train a visual entity extraction model within the visual entity extraction subcircuitry 121.

An example user triggers usage of the controllable multimodal meeting summarization system 100 by providing input. In this example, example user A chooses variables 104 such as start and end times, a user to focus on, or key words or phrases to focus on for the controllable multimodal meeting summarization system 100. The variables 104 are input into the extractive summarization circuitry 110 to provide contextual parameters, and are also input as for processing logic of text input extraction 112.

An example user may input past highlights, keywords, or previous notes 106 into the controllable multimodal meeting summarization system 100. The input past highlights, keywords, or previous notes are uploaded to the semantic entity extraction circuitry 120 to train a textual entity extraction model within the textual entity extraction subcircuitry 122. The textual entity extraction model use natural language processing to extract semantic entities from the transcriptions and notes to classify segments of the data into agent, patient, and action entities of the uploaded data. For example, a BERT based model is used to pull out the semantic entities from the context (notes written about a past conversation between two people). In this example, the agent, patient, and action entities are identified from the past conversation. Data is uploaded for a training phase to train the textual entity extraction model to improve accuracy of the model during the inferencing phase.

The adjusted language model from the domain adaptation circuitry 116, the textual extraction of the input parameters 104 and extractive summary from the extractive summarization circuitry 110, the visual entities extracted from the model of the visual entity extraction subcircuitry 121, and the textual entities extracted from the model of the textual entity extraction subcircuitry 122 are all input to the abstractive summarization circuitry 125 where incremental summarization is performed. The abstractive summarization circuitry in the training phase trains an abstractive summarization model to generate a summary 126 based on the visual and textual entities identified from the textual and visual entity extraction models of the textual and visual entity extraction circuitries as well as the text input extraction of the controllable input parameters 104 while taking into account the language context or domain generated by the adjusted language model of the domain adaptation circuitry 116. Incremental summarization takes the adjusted language model of the domain adaptation circuitry and uses the learned representations from the noise, augmented data, and original datasets to collect context from the extractive summary using the extracted textual and visual semantic entities. Then the context is returned incrementally for a preset cadence by performing the steps of collecting transcriptions for the window of time, collecting human provided notes, obtaining an extractive summary of the semantic entities for the window of time, and performing a union of the previous context and the current summary. The summarization models are capable of generating text, images, or other media in response to the input. The summarization models are generative, meaning the models learn the patterns and structure of the input training data and generate new data having similar characteristics.

FIG. 1B is a block diagram of an example environment in which an example controllable multimodal meeting summarization system 100 operates in the inferencing phase. The controllable multimodal meeting summarization system 100 operates to apply trained models to take multimodal input, historical data, and instructions from a user, then output a summary specific to a language domain.

FIG. 1B starts with example persons A, B, C, and D having a meeting in conferencing environment 102. Notetaking is automatically performed in real-time on each user. The automatically generated notes are sent to the extractive summarization circuitry 110 which creates an extractive summary using the developed extractive summarization model, placing emphasis on the input variables 104 controlled by example person A, B, C, or D initializing the controllable multimodal meeting summarization system 100. The extractive summarization model acts to embed sentences from the transcription into the model, run a clustering algorithm to identify clusters of context, and find sentences closest to a centroid of each cluster. The input variables 104 are input into the extractive summarization circuitry 110 and text input extraction 112 to control factors such as the start and end time, users to highlight, words or phrases to pay particular attention, etc. The extractive summary, along with the input variables 104, are sent to a text input extraction processing logic 112 of the example controllable multimodal meeting summarization system 100. Once the text input is extracted, the extractive summary text is sent to the abstractive summarization circuitry 125.

The video frames from the meeting held in conferencing environment 102 are sent to video input extraction processing logic of the controllable multimodal meeting summarization system 100. Frames are extracted from a sequence and sent to the semantic entity extraction circuitry 120, specifically the visual entity extraction subcircuitry 121. The visual entity extraction subcircuitry 121 applies the learned visual entity extraction model to extract visual entities and send them to the abstractive summarization circuitry 125.

Additional data 106 is input into the example controllable multimodal meeting summarization system 100, such as past meeting highlights, keywords, previous notes, etc. This data is input to the textual entity extraction subcircuitry 122 of the semantic entity extraction circuitry 120. At the textual entity extraction subcircuitry 122, textual entities are identified using a learned textual entity extraction model, tokenized, then sent to the abstractive summarization circuitry 125.

The abstractive summarization circuitry 125 uses a learned abstractive summarization model to generate a summary 126 given the inputs from the text input extraction 112, the visual entity extraction subcircuitry 121, and the textual entity extraction subcircuitry 122. The inputs are constrained by a language context generated from the model training of domain adaptation circuitry 116 of FIG. 1A.

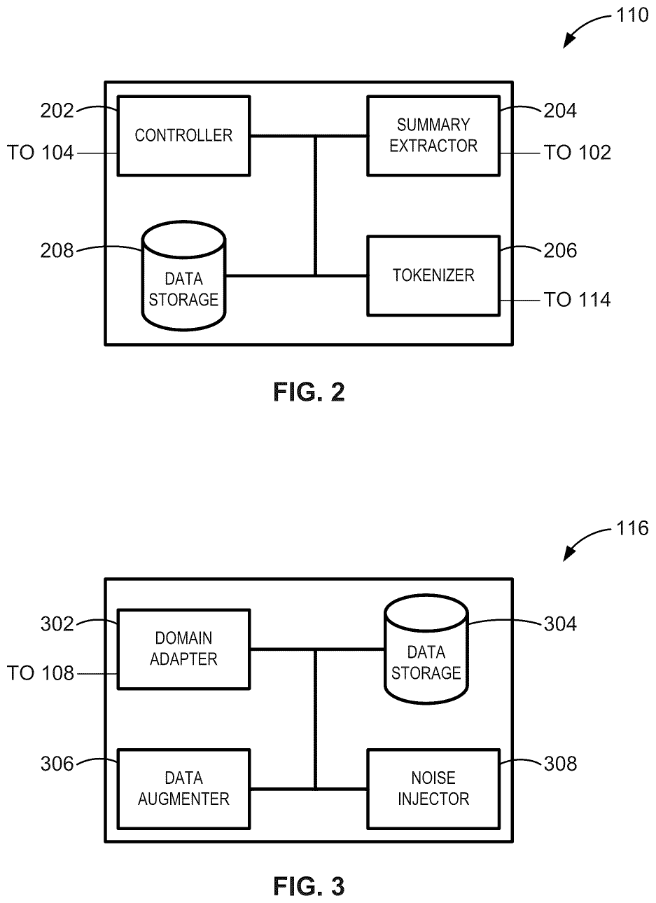

FIG. 2 is a block diagram of an example implementation of the extractive summarization circuitry 110 of FIGS. 1A and 1B to summarize user utterances into highlights. The extractive summarization circuitry 110 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the extractive summarization circuitry 110 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example extractive summarization circuitry 110 includes an example controller 202, an example summary extractor 202, an example tokenizer 206, and example data storage 208.

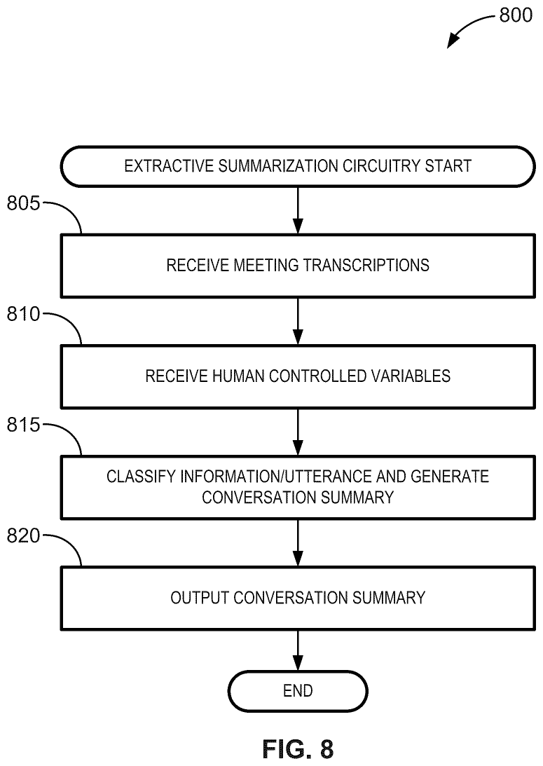

The example controller 202 of the extractive summarization circuitry 110 takes user input for parameters to be controlled in a context of a conferencing environment. For example, if user B wants to automatically summarize a conversation being held by users A, B, C, and D, user B has the ability to control the start and end time of the summary. User B also has the ability to control which users to focus on, phrases or keywords to pay attention to, etc. All of these parameters are input to the example controller 202 as dictated by user B. In some examples, the controller circuitry 202 is instantiated by programmable circuitry executing user input instructions and/or configured to perform operations such as those represented by the flowchart(s) of FIG. 8.

After being triggered to generate a summary by extracting the various details in a larger pool of information, example extractive summarization circuitry 110 relies on the example summary extractor 204 to perform extractive summarization. In a conferencing environment where a meeting is being held, the example summary extractor operates to shorten the automatic audio transcriptions to represent the most important information. This is done through binary classification highlighting the utterances classified as useful or relevant. For example, in a meeting between users A, B, C, and D, the summary extractor summarizes the content of the meeting by putting emphasis on details classified as important. In this example, a BERT language base is leveraged. In other examples, a language model such as BART, GPT-4 or another large-language model may be used as the language base. In some examples, the summary extractor 204 is instantiated by programmable circuitry executing summary generation instructions and/or configured to perform operations such as those represented by the flowchart(s) of FIG. 8.

The example tokenizer 206 performs tokenization of the extracted summary. The extracted data summarizing the content of the audio transcriptions are replaced with surrogate values while preserving the data format. For example, the summary of what user D says in the context of a conferencing environment on a given subject may be identified as important and tokenized. In some examples, the tokenizer 206 is instantiated by programmable circuitry executing tokenization instructions and/or configured to perform operations such as those represented by the flowchart(s) of FIG. 8.

The example data storage 208 is included in the extractive summarization circuitry for the purposes of data storage and retrieval. Data storage may be instantiated as a database, files, a data structure, etc. The example data storage 208 is implemented by any memory, storage device and/or storage disc for storing data such as flash memory, magnetic media, optical media, etc. Furthermore, the data stored in the example data storage 208 can be in any data format such as binary data, comma delimited data, tab delimited data, structured query language (SQL) structures, image data, etc. As meeting transcriptions and user control parameters are input, the data is stored in the data storage 208. A language base is stored and retrieved from the data storage 208. After a summary is extracted and tokenization occurs, the data is stored in data storage 208 before being sent to the abstractive summarization circuitry 125. For example, person A, B, and C hold a meeting in a conferencing environment. The extractive summarization circuitry 110 is triggered by person C initiating usage of the controllable multimodal meeting summarization system 100. The important information is extracted leveraging an example BERT language base from data storage 208 and summarized, tokenized, then the tokens are sent to the abstractive summarization circuitry 125. In other examples, a BART language model or other large language model may be used as the language base. In some examples, the data storage is instantiated by programmable circuitry executing data storage and retrieval instructions and/or configured to perform operations such as those represented by the flowchart(s) of FIG. 8.

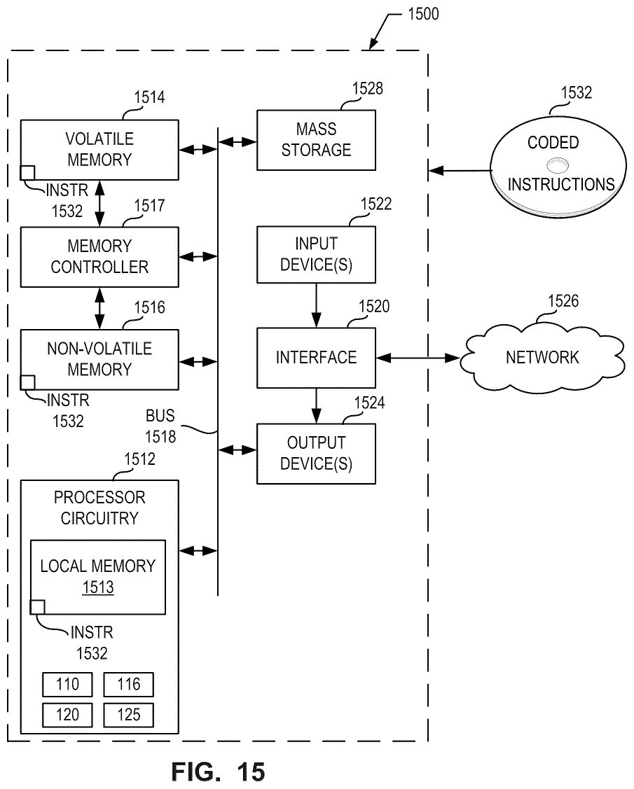

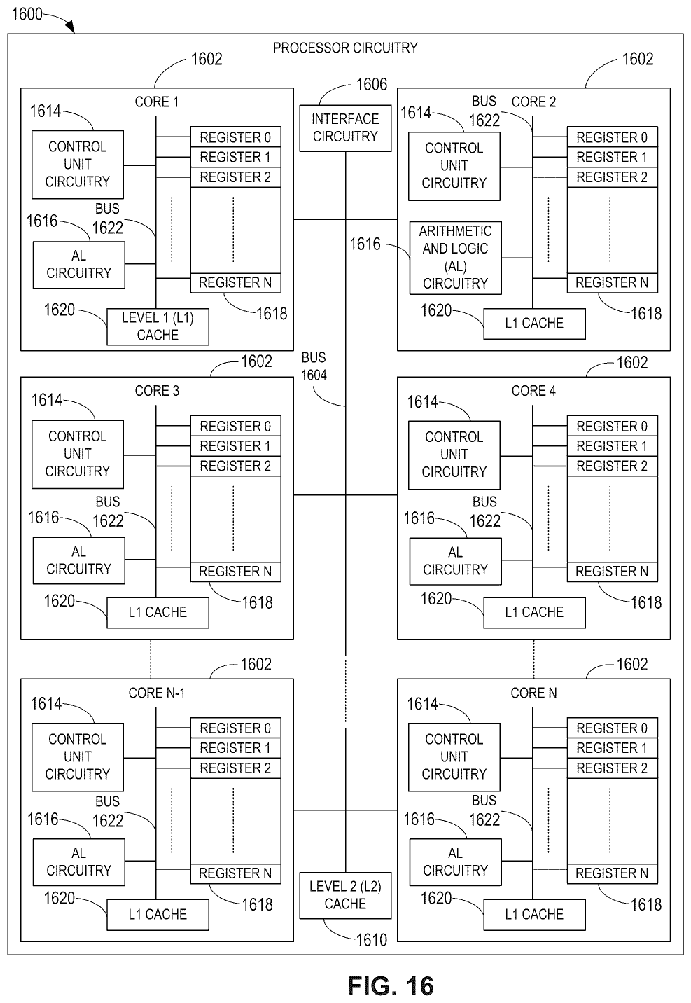

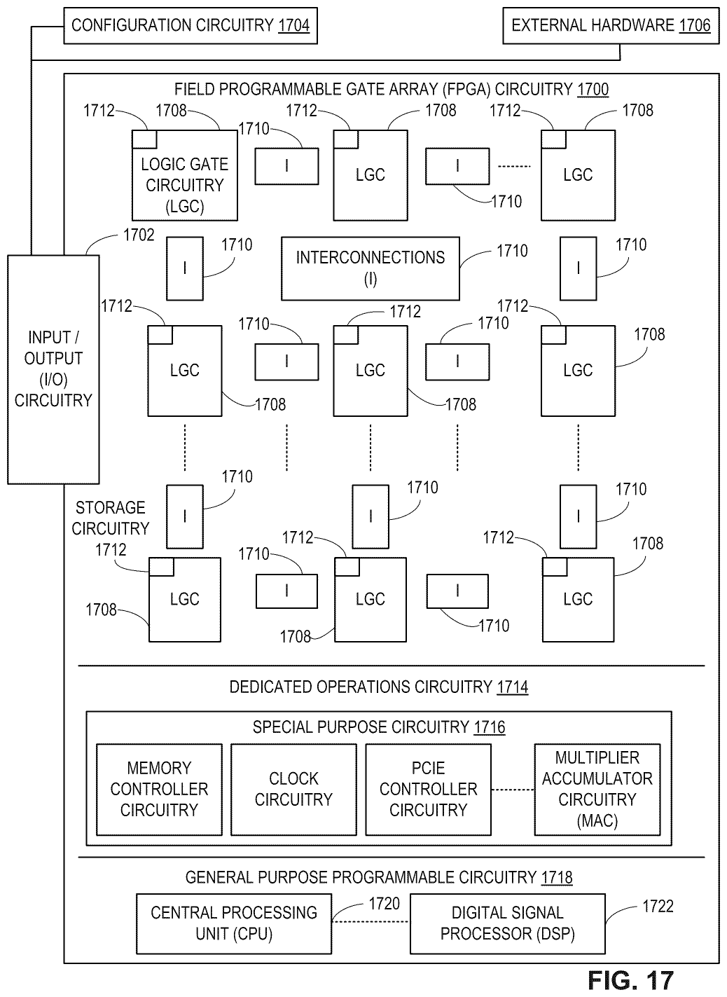

In some examples, the apparatus includes means for extractively summarizing audio transcriptions of a conferencing environment. For example, the means for extractively summarizing may be implemented by extractive summarization circuitry 110. In some examples, the extractive summarization circuitry 110 may be instantiated by programmable circuitry such as the example programmable circuitry 1512 of FIG. 15. For instance, the extractive summarization circuitry 110 may be instantiated by the example microprocessor 1600 of FIG. 16 executing machine executable instructions such as those implemented by at least blocks 815, 820 of FIG. 8. In some examples, the extractive summarization circuitry 110 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the extractive summarization circuitry 110 may be instantiated by any other combination of hardware, software, and/or firmware. For example, the extractive summarization circuitry 110 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 3 is a block diagram of an example implementation of the example domain adaptation circuitry 116 of FIG. 1 to adjust a language knowledge base (language domain) based on domain-specific data. The example domain adaptation circuitry 116 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the example domain adaptation circuitry 116 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The example domain adaptation circuitry 116 of FIG. 3 includes an example domain adapter 302, example data storage 304, an example data augmenter 306, and an example noise injector 308.

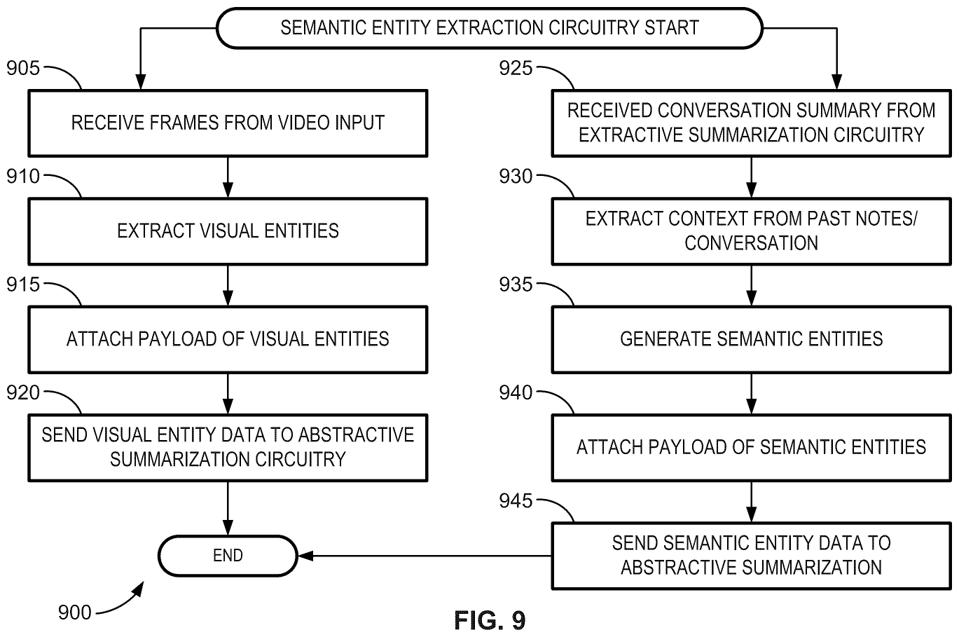

The example domain adapter 302 adjusts an existing language base during the training phase to incorporate language terms specific to a context or domain. A context or domain could include a commonality such as a common theme, a common topic, a common employer, a common geographic area, etc. The example domain adapter 302 accepts unlabeled domain-specific data and adjusts an existing language model to incorporate the data. For example, if an intra-office memo is sent via email, the email could be uploaded without labels to the domain adaptation circuitry 116, and more specifically the data storage 304. The domain adapter accesses the email from data storage 304 and adjusts an existing language model to incorporate terms that are specific to the company, office, or group of people to which the memo is relevant. In some examples, the domain adapter circuitry 302 is instantiated by programmable circuitry executing domain adaptation instructions and/or configured to perform operations such as those represented by the flowchart(s) of FIG. 9.

The example domain adaptation circuitry 116 also includes example data storage 304. Data storage may be instantiated as a database, files, a data structure, etc. The example data storage 304 is implemented by any memory, storage device and/or storage disc for storing data such as flash memory, magnetic media, optical media, etc. Furthermore, the data stored in the example data storage 304 can be in any data format such as binary data, comma delimited data, tab delimited data, structured query language (SQL) structures, image data, etc. The example data storage 304 serves to store a language model to be adjusted. Additionally, domain-specific data is uploaded through the data storage 304 for later usage. In some examples, the data storage circuitry 304 is instantiated by programmable circuitry executing data storage instructions and/or configured to perform operations such as those represented by the flowchart(s) of FIG. 9.

The example domain adaptation circuitry 116 also includes an example data augmenter 306. The example data augmenter 306 operates to extrapolate the data uploaded to the example domain adaptation circuitry 116 for improvement of the language model developed. The amount of data uploaded is artificially increased by generating new data points. For example, if 100,000 data points are uploaded to the domain adaptation circuitry 116, the data augmenter 306 operates to enhance the number of data points to improve the language model developed through the training phase. In this example, new points are artificially generated until 125,000 data points are available for development of the language model. In some examples, the data augmenter circuitry 306 is instantiated by programmable circuitry executing data augmentation instructions and/or configured to perform operations such as those represented by the flowchart(s) of FIG. 9.

The example domain adaptation circuitry 116 also includes an example noise injector 308. Example noise injector 308 takes input data points and uses noise injection to introduce noise into the data. Between training iterations, a noise vector can be added to each training case to add supplemental data for the purposes of enhancing the language model. In some examples, the noise injector circuitry 308 is instantiated by programmable circuitry executing noise injection instructions and/or configured to perform operations such as those represented by the flowchart(s) of FIG. 9.

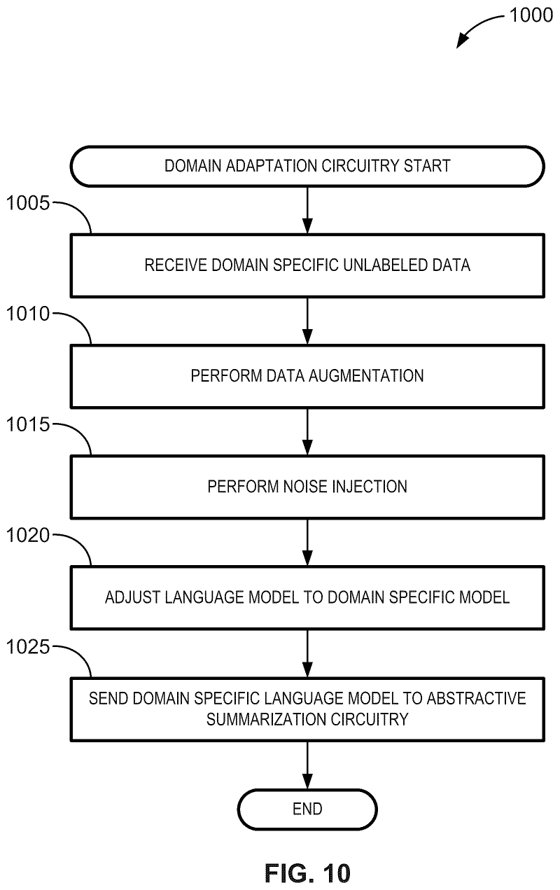

In some examples, the apparatus includes means for adjusting a domain. For example, the means for adjusting may be implemented by domain adaptation circuitry 116. In some examples, the domain adaptation circuitry 116 may be instantiated by programmable circuitry such as the example programmable circuitry 1512 of FIG. 15. For instance, the domain adaptation circuitry 116 may be instantiated by the example microprocessor 1600 of FIG. 16 executing machine executable instructions such as those implemented by at least blocks 1005, 1010, 1015, and 1020 of FIG. 10. In some examples, domain adaptation circuitry 116 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the domain adaptation circuitry 116 may be instantiated by any other combination of hardware, software, and/or firmware. For example, the domain adaptation circuitry 116 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

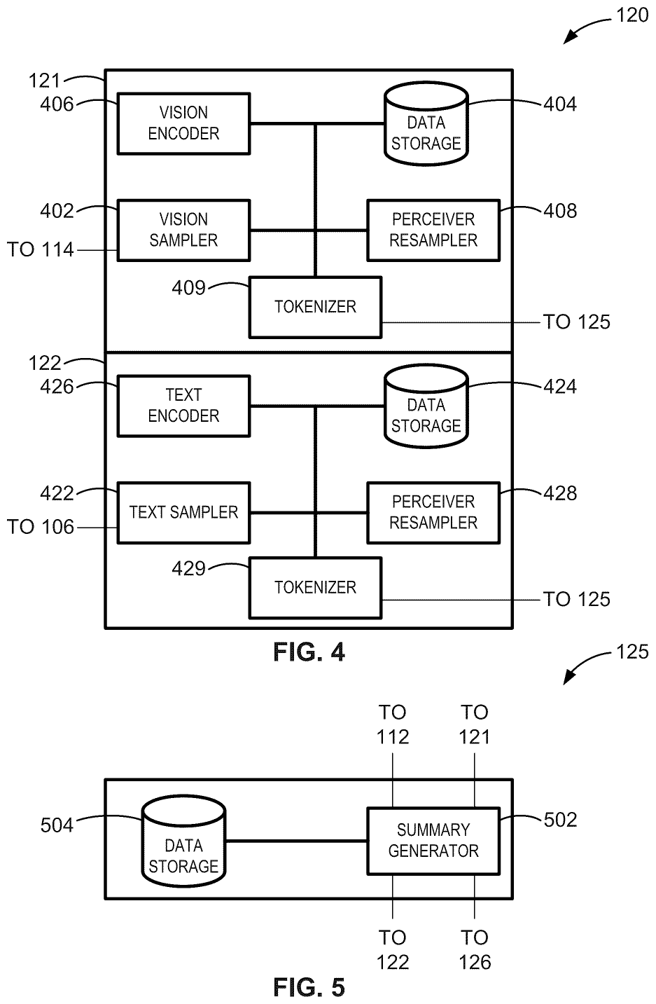

FIG. 4 is a block diagram of an example implementation of the example semantic entity extraction circuitry 120 of FIGS. 1A and 1B to extract semantic entities into tokens with associated payloads. The example semantic entity extraction circuitry 120 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the semantic entity extraction circuitry 120 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

The example semantic entity extraction circuitry 120 includes the example textual entity extraction subcircuitry 122 and example visual entity extraction subcircuitry 121. Each subcircuitry includes an example text or vision encoder 406, 426, an example data storage 404, 424, an example visual or textual sampler 402, 422, an example perceiver resampler 408, 428, and an example tokenizer 409, 429.

The example visual entity extraction subcircuitry 121 includes an example visual sampler. The example visual sampler operates using a clustering algorithm to sample from input frames. For example, an example visual sampler 402 uses k-means sampling to cluster a number of n video frames into k clusters. In some examples, the visual sampler circuitry 402 is instantiated by programmable circuitry executing visual sampling instructions and/or configured to perform operations such as those represented by the flowchart(s) of FIG. 10.

The example visual entity extraction subcircuitry 121 includes example data storage 404. Data storage may be instantiated as a database, files, a data structure, etc. The example data storage 404 is implemented by any memory, storage device and/or storage disc for storing data such as flash memory, magnetic media, optical media, etc. Furthermore, the data stored in the example data storage 404 can be in any data format such as binary data, comma delimited data, tab delimited data, structured query language (SQL) structures, image data, etc. In some examples, the example data storage circuitry 404 is instantiated by programmable circuitry executing data storage instructions and/or configured to perform operations such as those represented by the flowchart(s) of FIG. 10.

The example visual entity extraction subcircuitry 121 includes an example vision encoder 406. The example vision encoder takes the clustering data as input data and compresses the data into an encoded visual sequence. In some examples, the vision encoder circuitry 406 is instantiated by programmable circuitry executing vision encoding instructions and/or configured to perform operations such as those represented by the flowchart(s) of FIG. 10.

The example visual entity extraction subcircuitry 121 includes an example perceiver resampler 408. The example perceiver resampler takes a variable number of encoded data from the vision encoder and resamples the data to a small, fixed number of outputs. These outputs are a representative fixed number of data. The output data is representative of the visual sequence used as input, and is the data is saved for semantic entity extraction to obtain an extracted semantic entity. In some examples, the perceiver resampler circuitry 408 is instantiated by programmable circuitry executing resampling instructions and/or configured to perform operations such as those represented by the flowchart(s) of FIG. 10.

The example visual entity extraction subcircuitry 121 includes an example tokenizer 409. The example tokenizer 409 attaches a payload to each visual entity extracted and tokenizes the data for the abstractive summarization circuitry 125. In some examples, the tokenizer circuitry 409 is instantiated by programmable circuitry executing tokenization instructions and/or configured to perform operations such as those represented by the flowchart(s) of FIG. 10.

The example textual entity extraction subcircuitry 122 includes an example textual sampler. The example textual sampler operates by sampling transcriptions as input. In some examples, the textual sampler circuitry 422 is instantiated by programmable circuitry executing visual sampling instructions and/or configured to perform operations such as those represented by the flowchart(s) of FIG. 10.

The example textual entity extraction subcircuitry 122 includes example data storage 424. Data storage may be instantiated as a database, files, a data structure, etc. The example data storage 424 is implemented by any memory, storage device and/or storage disc for storing data such as flash memory, magnetic media, optical media, etc. Furthermore, the data stored in the example data storage 424 can be in any data format such as binary data, comma delimited data, tab delimited data, structured query language (SQL) structures, image data, etc. In some examples, the data storage circuitry 424 is instantiated by programmable circuitry executing data storage instructions and/or configured to perform operations such as those represented by the flowchart(s) of FIG. 10.

The example textual entity extraction subcircuitry 122 includes an example text encoder 426. The example text encoder takes the sampled transcription data as input data and compresses the data into an encoded representation. In some examples, the example text encoder circuitry 426 is instantiated by programmable circuitry executing vision encoding instructions and/or configured to perform operations such as those represented by the flowchart(s) of FIG. 10.

The example textual entity extraction subcircuitry 122 includes an example perceiver resampler 428. The example perceiver resampler takes the encoded transcription from the textual encoder and resamples the data to a small, fixed number of outputs. The output data is representative of the transcriptions used as input, and is the data is saved for semantic entity extraction. In some examples, the perceiver resampler circuitry 428 is instantiated by programmable circuitry executing resampling instructions and/or configured to perform operations such as those represented by the flowchart(s) of FIG. 10.

The example textual entity extraction subcircuitry 122 includes an example tokenizer 429. The tokenizer 429 attaches a payload to each textual entity extracted and tokenizes the data for the abstractive summarization circuitry 125. In some examples, the tokenizer circuitry 409 is instantiated by programmable circuitry executing tokenization instructions and/or configured to perform operations such as those represented by the flowchart(s) of FIG. 10.

In some examples, the apparatus includes means for extracting a semantic entity. For example, the means for extracting may be implemented by semantic entity extraction circuitry 120. In some examples, the semantic entity extraction circuitry 120 may be instantiated by programmable circuitry such as the example programmable circuitry 1512 of FIG. 15. For instance, the semantic entity extraction circuitry 120 may be instantiated by the example microprocessor 1600 of FIG. 16 executing machine executable instructions such as those implemented by at least blocks 910, 930, 935 of FIG. 9. In some examples, semantic entity extraction circuitry 120 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the semantic entity extraction circuitry 120 may be instantiated by any other combination of hardware, software, and/or firmware. For example, the semantic entity extraction circuitry 120 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 5 is a block diagram of an example implementation of the example abstractive summarization circuitry 125 of FIGS. 1A and 1B to create an abstract summary of a conferencing summary leveraging semantic entities extracted from context data and the adjusted language model adapted from context data. The example abstractive summarization circuitry 125 of FIG. 5 may be instantiated (e.g., creating an instance of, bring into being for any length of time, materialize, implement, etc.) by programmable circuitry such as a Central Processor Unit (CPU) executing first instructions. Additionally or alternatively, the abstractive summarization circuitry 125 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

The example abstractive summarization circuitry 125 includes an example summary generator 502 and example data storage 504.

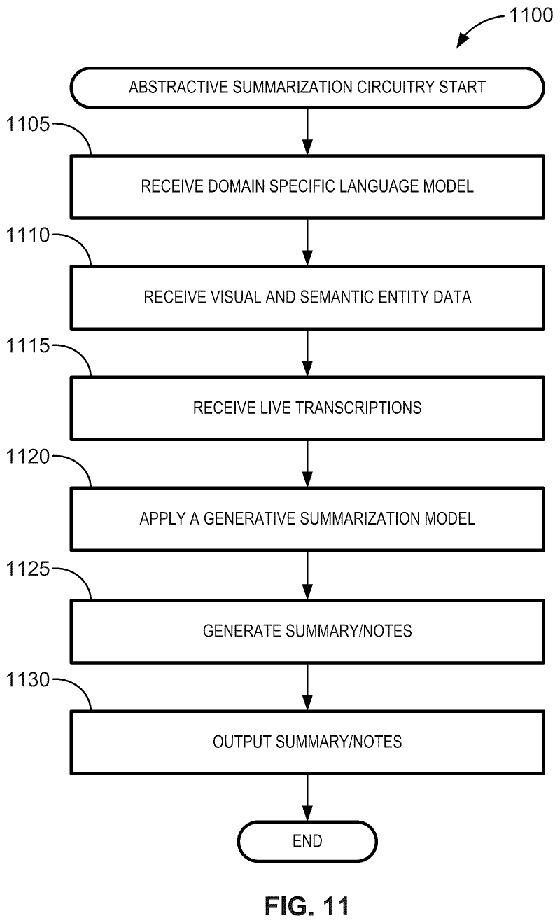

The example data storage 504 is used to store and allow retrieval of the domain adapted language model, the extractive summary, and semantic entity tokens. Data storage may be instantiated as a database, files, a data structure, etc. The example data storage 504 is implemented by any memory, storage device and/or storage disc for storing data such as flash memory, magnetic media, optical media, etc. Furthermore, the data stored in the example data storage 504 can be in any data format such as binary data, comma delimited data, tab delimited data, structured query language (SQL) structures, image data, etc. In some examples, the example data storage circuitry 504 is instantiated by programmable circuitry executing data storage instructions and/or configured to perform operations such as those represented by the flowchart(s) of FIG. 11.

The example summary generator 502 inferences a summary through a model requiring the inputs of a language domain, tokenized semantic entities, an extractive summary of live transcriptions, and the live transcriptions collected from a current window of time. The inferencing is done in real-time. In some examples, the example summary generator circuitry 502 is instantiated by programmable circuitry executing summary generation instructions and/or configured to perform operations such as those represented by the flowchart(s) of FIG. 11.

In some examples, the apparatus includes means for abstractively summarizing. For example, the means for summarizing may be implemented by abstractive summarization circuitry 125. In some examples, the abstractive summarization circuitry 125 may be instantiated by programmable circuitry such as the example programmable circuitry 1512 of FIG. 15. For instance, the abstractive summarization circuitry 125 may be instantiated by the example microprocessor 1600 of FIG. 16 executing machine executable instructions such as those implemented by at least blocks 1120, 1125 of FIG. 11. In some examples, abstractive summarization circuitry 125 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the abstractive summarization circuitry 125 may be instantiated by any other combination of hardware, software, and/or firmware. For example, the abstractive summarization circuitry 125 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

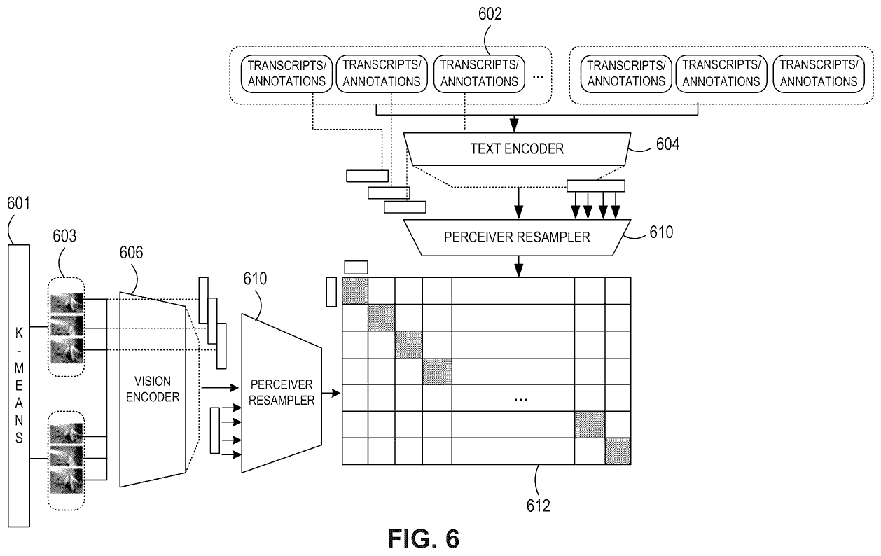

FIG. 6 highlights the example extractive summarization circuitry 110 is greater detail. In the example shown, k-means clustering 601 is used to sample input frames from video in a sequence (not shown). From there, an example vision encoder 606 is used to encode the representative clusters 603. Any pooler is removed from the process and replaced with an example perceiver resampler 610 which takes the output from the vision encoder along with learned latent queries. The output is the extracted visual entity data 612.

In parallel, the example extractive summarization circuitry 110 also processes textual entities. Input transcripts and annotations 602 are used by a text encoder 604. The encoded data is sent to the perceiver resampler 610 which uses the encoded data along with learned latent queries to produce textual entity data 612.

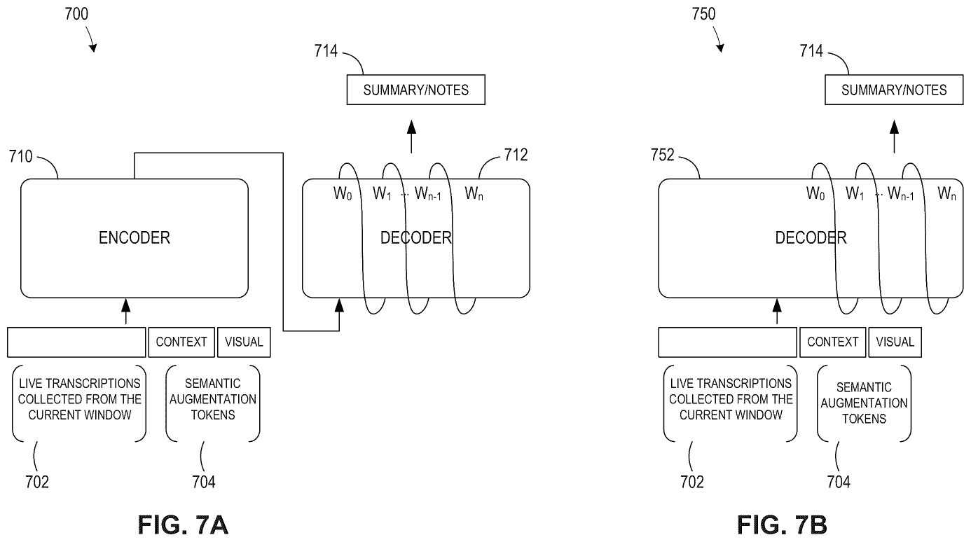

FIGS. 7A and 7B show example architecture of the abstractive summarization circuitry 125. As demonstrated in FIG. 7A, an example architecture of the abstractive summarization circuitry 125 architecture is an encoder/decoder architecture 700. In an encoder/decoder example 700, the live transcriptions collected from the current window 702 and example semantic augmentation tokens 704 are input to an encoder 710. The inputs are of variable-length and are transformed by the encoder 710 into a state with a fixed shape. The decoder 712 takes the encoded state of the fixed shape and maps to a variable-length sequence to output a summary or notes 714 of the inputs.

An alternate architecture of the example abstractive summarization circuitry 125 is shown in FIG. 7B as a decoder-only architecture. In decoder-only architecture, the model consists of a decoder 752 which takes the inputs of live transcriptions 702 and semantic augmentation tokens 704. The example decoder 752 is trained to predict the next token in sequence given the previous tokens. The example decoder 752 outputs a summary or notes 714 using this method.

While an example manner of implementing the controllable multimodal meeting summarization system 100 of FIG. 1 is illustrated in FIG. 1A, one or more of the elements, processes, and/or devices illustrated in FIG. 1A may be combined, divided, re-arranged, omitted, eliminated, and/or implemented in any other way. Further, the extractive summarization circuitry 110, domain adaptation circuitry 116, semantic entity extraction circuitry 120, and abstractive summarization circuitry 125, and/or, more generally, the example controllable multimodal meeting summarization system 100 of FIG. 1A, may be implemented by hardware alone or by hardware in combination with software and/or firmware. Thus, for example, any of the extractive summarization circuitry 110, domain adaptation circuitry 116, semantic entity extraction circuitry 120, and abstractive summarization circuitry 125, and/or, more generally, the example controllable multimodal meeting summarization system 100, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example controllable multimodal meeting summarization system 100 of FIG. 1A may include one or more elements, processes, and/or devices in addition to, or instead of, those illustrated in FIG. 1A, and/or may include more than one of any or all of the illustrated elements, processes and devices.

Flowcharts representative of example machine readable instructions, which may be executed by programmable circuitry to implement and/or instantiate the controllable multimodal meeting summarization system 100 of FIG. 1A and/or representative of example operations which may be performed by programmable circuitry to implement and/or instantiate the controllable multimodal meeting summarization system 100 of FIG. 1A, are shown in FIGS. 8-11. The machine readable instructions may be one or more executable programs or portion(s) of one or more executable programs for execution by programmable circuitry such as the programmable circuitry 1512 shown in the example processor platform 1500 discussed below in connection with FIG. 15 and/or may be one or more function(s) or portion(s) of functions to be performed by the example programmable circuitry (e.g., an FPGA) discussed below in connection with FIGS. 16 and/or 17. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 8-11, many other methods of implementing the example controllable multimodal meeting summarization system 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 8-11 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a flowchart representative of example machine readable instructions and/or example operations 800 that may be executed, instantiated, and/or performed by programmable circuitry to perform extractive summarization. The example machine-readable instructions and/or the example operations 800 of FIG. 8 begin at block 805, at which the data storage receives a meeting transcription. Reception of a meeting transcription 805 involves receiving input from a conferencing environment of an automatic meeting transcription. In this example, persons A, B, C, and D gather in a multimodal conferencing environment to have a meeting. The meeting transcription is automatically generated in the conferencing environment and sent to the abstractive summarizer 110. The abstractive summarizer 125 receives the meeting transcription 805.

While the example extractive summarizer receives the meeting transcription (block 805), the example extractive summarizer also receives human controlled variables from a user. In this example, person A, B, C, or D may be the user of the controllable multimodal meeting summarization system 100. In this example, person A chooses a start time and end time for the extractive summarization circuitry 110 to perform extractive summarization. Additionally, person A has the ability to choose a person to focus on, such as person C. Furthermore, person A can choose words or phrases from a language base to further focus the extractive summarization circuitry 110. The start time, end time, person of focus, words or phrases of focus and other human controlled variables are all received by the extractive summarization circuitry 810.

After the example extractive summarization circuitry 110 has received the meeting transcription(s) (block 805) and the human controlled variables (block 810), the example extractive summarization circuitry 110 performs a classification of information and utterances in the conferencing environment to generate a conversation summary (block 815). In this example, the example extractive summarization circuitry 110 has a language model stored and leverages the language model to summarize the utterances and information associated with the conferencing environment. The example extractive summarization circuitry 110 uses binary classification to highlight any utterance or information deemed useful or relevant to generating a summary. The example extractive summarization circuitry 110 selects a subset of existing words, phrases or sentences from the utterances and information provided in conjunction with the binary classification to form a summary.

The next step the example extractive summarization circuitry 110 performs is outputting and sending the generated conversation summary (block 820). After the example extractive summarization circuitry 110 forms a useful and usable summary, the summary is output for text input extraction and also sent to the semantic entity extraction circuitry 120. In this example, the extractive summarization circuitry 110 outputs a summary of the meeting transcription of persons A, B, C, and D in their conferencing environment given the constraints person A input as human controlled variables as an input to both the text input extraction and semantic entity extraction circuitry 120.

FIG. 9 is a flowchart representative of example machine readable instructions and/or example operations 900 that may be executed, instantiated, and/or performed by programmable circuitry to perform semantic entity extraction. The example machine-readable instructions and/or the example operations 900 of FIG. 9 begin at block 905, at which the data storage 404. operates to receive frames from a video input of a conferencing environment. In this example, persons A, B, C, and D held a meeting in a conferencing environment. A video input is taken from the meeting, and frames are extracted as input to the visual entity extraction subcircuitry 121 of the semantic entity extraction circuitry 120.

The extracted video frame input is then used by the example visual entity extraction subcircuitry 121 to extract visual entities in the frames. This is performed through sampling by an example vision sampler 402, encoding by an example vision encoder 406, and resampling by an example perceiver resampler 408. In this example, a sampler uses k-means clustering to cluster the frames from a batch of frames into representative clusters. The example representative clusters are then encoded by an example vision encoder 406 to compress the input data into an encoded representation. The encoded representation is then resampled by an example perceiver resampler 408. The example perceiver resampler 408 receives a set number of features from the vision encoder 406 and outputs a fixed-size set of visual tokens representing the extracted visual entities. A payload of each visual entity is then attached to each visual token 915. In this example, the visual entity extraction subcircuitry 121 attaches a payload to each of the visual tokens extracted by the example perceiver resampler 408.

The example visual entity extraction subcircuitry 121 of the semantic entity extraction sends the visual tokens with the attached payloads as visual entity data to an example abstractive summarization circuitry 125, as indicated in block 920.

In parallel to the visual entity extraction subcircuitry 121, a textual entity extraction subcircuitry 122 is included in the semantic entity extraction circuitry 120. The example machine-readable instructions and/or the example operations 900 of FIG. 9 begin at block 925, at which the extractive summarization circuitry sends a conversation summary to the example textual entity extraction subcircuitry. The example textual entity extraction subcircuitry receives the conversation summary. In this example, the example extractive summarization circuitry sends a conversation summary of the meeting persons A, B, C, and D held in the conferencing environment. The Conversation summary was constrained by person A to focus on person C from a given start time to an end time while focusing on input words and phrases. The meeting transcription was processed by the extractive summarization circuitry 110 to produce the conversation summary. The example extractive summarization circuitry 110 then sends the conversation summary to the example semantic entity extraction circuitry 120, and more specifically, the textual entity extraction subcircuitry 122.

The example textual entity extraction subcircuitry 122 also receives input from a user regarding past highlights, keywords, or other contextual notes. The example textual entity extraction circuitry works to extract a context from the user input, past notes, and the conversation summary sent by the example extractive summarization circuitry 110. For example, user A uploads notes from a past conversation between persons A, B, and D. The textual entity extraction subcircuitry 122 extracts a context from the uploaded notes.

After the example textual entity extraction subcircuitry 122 extracts a context from past notes and receives the conversation summary from the example extractive summarization circuitry 110, the example semantic entity extraction circuitry 120 identifies semantic entities and generates semantic entity tokens 935. The transcriptions and notes are extracted into semantic roles, such as agent, patient and action. The semantic role entities are used to augment the input to abstractive summarization circuitry.

Upon identifying the semantic entities and generating semantic entity tokens, a payload is attached to each token 940. This is subsequently sent from the semantic entity extraction circuitry 120 to an abstractive summarization circuitry 945.

In a parallel pathway to the semantic entity extraction circuitry 120, a domain adaptation circuitry 116 works to adapt a language model to a domain-specific model. FIG. 10 is a flowchart representative of example machine readable instructions and/or example operations 1000 that may be executed, instantiated, and/or performed by programmable circuitry to adjust a language domain. The example machine-readable instructions and/or the example operations 1000 of FIG. 10 begin at block 1005, at which the data storage 304 receives domain-specific unlabeled data. The domain-specific unlabeled data is uploaded to the example domain adaptation circuitry for the purposes of implementing a training phase of model formation. The unlabeled data may include databases, documents, emails, memos, or other information particular to a given domain. For example, a database of internal company terms is added to a BERT language model.

After the domain-specific unlabeled data is uploaded, the example domain adaptation circuitry 116 performs data augmentation, where new data points are generated from the existing data 1010.

In addition to data augmentation 1010, the example domain adaptation circuitry 116 also performs noise injection 1015, where noise is artificially added to the input data.

With the extrapolated dataset of input data, augmented data, and data with noise, the example domain adaptation circuitry 116 is able to adjust a language model to be a domain-specific model 1020. This domain adaptation is a self-supervised process of making the models re-learn the representations, which results in an improved domain-specific embedding.

After the language model is adjusted to be a domain-specific model, the domain-specific language model is sent to the abstractive summarization circuitry 125 to facilitate abstractive summarization 1025.

FIG. 11 is a flowchart representative of example machine readable instructions and/or example operations 1100 that may be executed, instantiated, and/or performed by programmable circuitry to perform abstractive summarization. The example machine-readable instructions and/or the example operations 1100 of FIG. 11 begin at block 1105, at which the data storage 504 receives the domain-specific language model 1105 learned by the domain adaptation circuitry.

In addition to receiving the domain-specific language model, the abstractive summarization circuitry 125 receives the visual and semantic entity data from the semantic entity extraction circuitry 1110.

Furthermore, the example abstractive summarization circuitry 125 receives the live transcriptions that have had text input extraction run 1115.

From these inputs of a domain-specific language model, the visual and semantic entity data, and the live transcriptions, the adaptive summarization circuitry is able to apply a generative summarization model 1120.

The generative summarization model application results in generating a summary or notes 1125. The input transcription is paraphrased using novel sentences in a manner that highlights the extracted visual and textual entities and ensures adherence to the language domain as learned and subsequently received in block 1105.

The summary or notes generated in block 925 are subsequently output 1130 by the abstractive summarization circuitry 125.

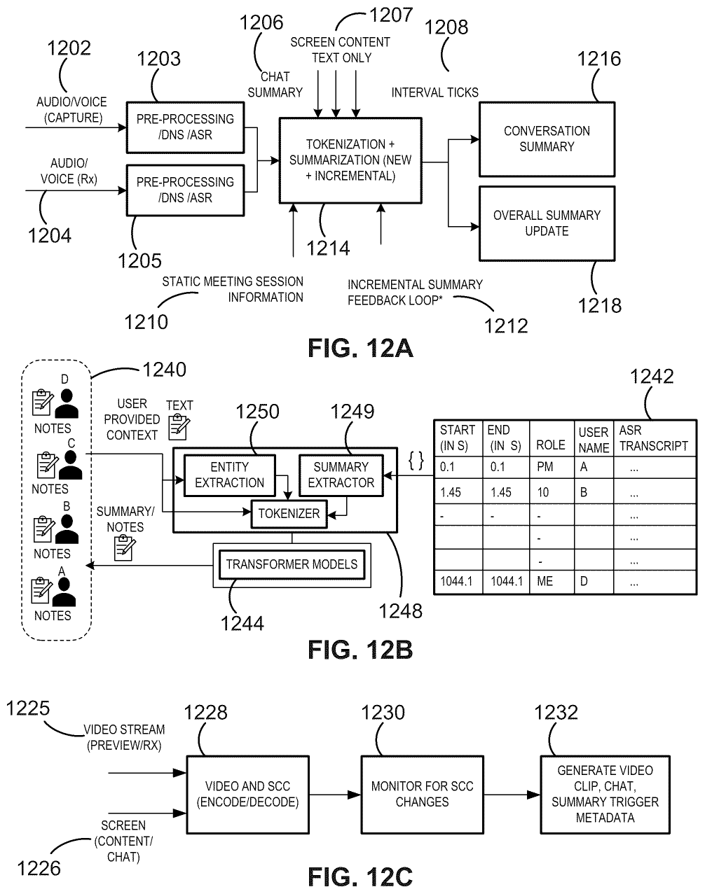

FIG. 12A is a block diagram showing the input and output data streams for the tokenization and summarization of the semantic entity extraction. This process starts with inputs of audio capture 1202 and an audio transcription 1204 being input to pre-processing 1203, 1205. After being pre-processed, the audio capture and transcription is input into a tokenization and summarization process 1214 along with accompanying data such as a chat summary 1206, screen context text 1207, interval ticks 1208, static meeting session information from the conferencing environment 1210, and an incremental summary feedback loop 1212. The tokenization and summarization process output a conversation summary 1216 and an overall summary update 1218.

FIG. 12B is a diagram showing the operation of the extractive summarization circuitry 110. First, users A, B, C, and D have notes taken regarding utterances of each individual 1240. The extractive summarization circuitry extracts the entities from these utterances 1250 and sends the data to a tokenizer 1245. The tokenizer takes the extracted entities and metadata input by a summary extractor 1249 to update a transformer model 1244. The transformer model then produces a summary or notes of the utterances of the individuals.

FIG. 12C is an example video stream process, where a video clip is generated for a given summary instance. For example, a video stream transcription 1225 and chat content 1226 are input into a video encoder/decoder process 1228. The encoder/decoder process is monitored for changes 1230, which result in video summary metadata being generated 1232.

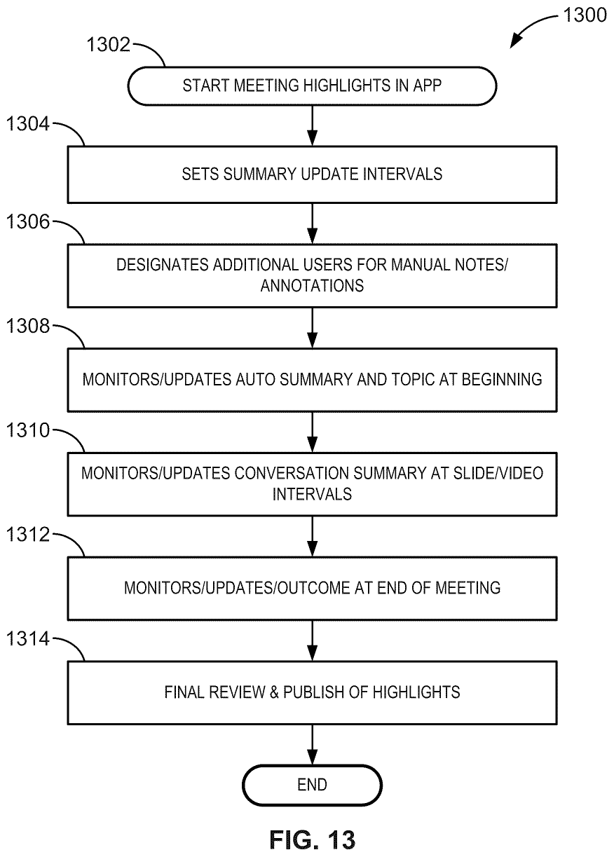

FIG. 13 is an example user workflow diagram, showing how an example user would interact with an interface to control the example extractive summarization circuitry 110, the example domain adaptation circuitry 116, the example semantic entity extraction circuitry 120, and the example abstractive summarization circuitry 125. The process of interacting with the interface begins at block 1302, where a user starts the meeting highlights in an application. For example, user/person A starts the meeting highlights in a conferencing environment involving persons A, B, C, and D.

Next, the example user sets the update intervals for the summary 1304. For example, user A may choose to set the summary update interval as an update every 10 minutes.

The user then designates additional users for manual notes and annotations for later comparison 1306. For example, person A may designate person D to take manual notes.

The auto-summary and topic are then monitored at the beginning of the summarization 1308. For example, person A will monitor the meeting highlight output summary and topic.

The example user is to continue to monitor the conversation summary at the predetermined intervals 1310. For example, person A will check the conversation summary every 10 minutes.

The example user will continue to monitor the summary until the end of the meeting or conclusion of the conferencing environment session 1312. For example, user A monitors the meeting highlight output summary and topic at the end of the meeting.

The example user then performs a final review of the highlights generated 1314 by the summarization tool. The highlights generated are published with the additional manual notes taken 1306. For example, person A will perform a final review of the highlights auto generated by the summarization tool and publish the highlights along with the additional manual notes of person D.

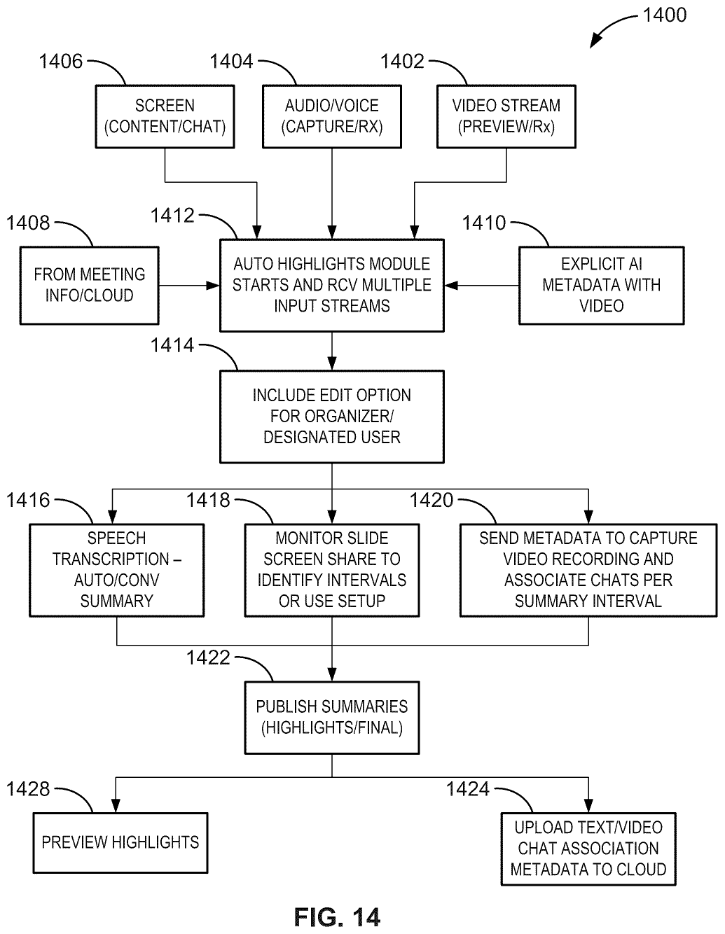

FIG. 14 is a system workflow diagram indicating the example workflow of an example summarization system. This begins with the input of chat content 1406, audio transcription 1404, and the video stream transcription 1402, the meeting session info 1408, and the explicit AI metadata with video 1410 into the auto-highlights module. The auto highlight module starts and receives the multimodal input streams 1412. The summarization system presents a user of the system with an edit option.

After the example summarization system is initialized, the example summarization system auto summarizes the speech transcription 1416, monitors screen sharing to identify intervals 1418, and sends metadata to capture video recordings and associated chats per a set summary interval 1420. When the conferencing environment is triggered to end, the summarization system publishes the summary highlights 1422. A user can then preview the highlights 1428, and the metadata of the uploaded text and video chat is uploaded to the cloud 1424, where the data is encoded 1426.

FIG. 15 is a block diagram of an example programmable circuitry platform 1500 structured to execute and/or instantiate the example machine-readable instructions and/or the example operations of FIGS. 8-11 to implement the controllable multimodal meeting summarization system 100 of FIG. 1A. The programmable circuitry platform 1500 can be, for example, a server, a personal computer, a workstation, a self-learning machine (e.g., a neural network), a mobile device (e.g., a cell phone, a smart phone, a tablet such as an iPad™), a personal digital assistant (PDA), or any other type of computing and/or electronic device.

The programmable circuitry platform 1500 of the illustrated example includes programmable circuitry 1512. The programmable circuitry 1512 of the illustrated example is hardware. For example, the programmable circuitry 1512 can be implemented by one or more integrated circuits, logic circuits, FPGAs, microprocessors, CPUs, GPUs, DSPs, and/or microcontrollers from any desired family or manufacturer. The programmable circuitry 1512 may be implemented by one or more semiconductor based (e.g., silicon based) devices. In this example, the programmable circuitry 1112 implements the extractive summarization circuitry 110, the domain adaptation circuitry 116, the semantic entity extraction circuitry 120, and the abstractive summarization circuitry 125.

The programmable circuitry 1512 of the illustrated example includes a local memory 1513 (e.g., a cache, registers, etc.). The programmable circuitry 1512 of the illustrated example is in communication with main memory 1514, 1516, which includes a volatile memory 1514 and a non-volatile memory 1516, by a bus 1518. The volatile memory 1514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1516 may be implemented by flash memory and/or any other desired type of memory device. Access to the main memory 1514, 1516 of the illustrated example is controlled by a memory controller 1517. In some examples, the memory controller 1517 may be implemented by one or more integrated circuits, logic circuits, microcontrollers from any desired family or manufacturer, or any other type of circuitry to manage the flow of data going to and from the main memory 1514, 1516.

The programmable circuitry platform 1500 of the illustrated example also includes interface circuitry 1520. The interface circuitry 1520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1522 are connected to the interface circuitry 1520. The input device(s) 1522 permit(s) a user (e.g., a human user, a machine user, etc.) to enter data and/or commands into the programmable circuitry 1512. The input device(s) 1522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1524 are also connected to the interface circuitry 1520 of the illustrated example. The output device(s) 1524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1520 of the illustrated example, thus, typically includes a graphics driver card, a graphics driver chip, and/or graphics processor circuitry such as a GPU.

The interface circuitry 1520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1500 of the illustrated example also includes one or more mass storage discs or devices 1528 to store firmware, software, and/or data. Examples of such mass storage discs or devices 1528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1532, which may be implemented by the machine readable instructions of FIGS. 8-11, may be stored in the mass storage device 1528, in the volatile memory 1514, in the non-volatile memory 1516, and/or on at least one non-transitory computer readable storage medium such as a CD or DVD which may be removable.

FIG. 16 is a block diagram of an example implementation of the programmable circuitry 1512 of FIG. 15. In this example, the programmable circuitry 1512 of FIG. 15 is implemented by a microprocessor 1600. For example, the microprocessor 1600 may be a general-purpose microprocessor (e.g., general-purpose microprocessor circuitry). The microprocessor 1600 executes some or all of the machine-readable instructions of the flowcharts of FIGS. 8-11 to effectively instantiate the circuitry of FIG. 2 as logic circuits to perform operations corresponding to those machine readable instructions. In some such examples, the circuitry of FIG. 1A is instantiated by the hardware circuits of the microprocessor 1600 in combination with the machine-readable instructions. For example, the microprocessor 1600 may be implemented by multi-core hardware circuitry such as a CPU, a DSP, a GPU, an XPU, etc. Although it may include any number of example cores 1602 (e.g., 1 core), the microprocessor 1600 of this example is a multi-core semiconductor device including N cores. The cores 1602 of the microprocessor 1600 may operate independently or may cooperate to execute machine readable instructions. For example, machine code corresponding to a firmware program, an embedded software program, or a software program may be executed by one of the cores 1602 or may be executed by multiple ones of the cores 1602 at the same or different times. In some examples, the machine code corresponding to the firmware program, the embedded software program, or the software program is split into threads and executed in parallel by two or more of the cores 1602. The software program may correspond to a portion or all of the machine readable instructions and/or operations represented by the flowcharts of FIGS. 8-11.

The cores 1602 may communicate by a first example bus 1604. In some examples, the first bus 1604 may be implemented by a communication bus to effectuate communication associated with one(s) of the cores 1602. For example, the first bus 1604 may be implemented by at least one of an Inter-Integrated Circuit (I2C) bus, a Serial Peripheral Interface (SPI) bus, a PCI bus, or a PCIe bus. Additionally or alternatively, the first bus 1604 may be implemented by any other type of computing or electrical bus. The cores 1602 may obtain data, instructions, and/or signals from one or more external devices by example interface circuitry 1606. The cores 1602 may output data, instructions, and/or signals to the one or more external devices by the interface circuitry 1606. Although the cores 1602 of this example include example local memory 1620 (e.g., Level 1 (L1) cache that may be split into an L1 data cache and an L1 instruction cache), the microprocessor 1600 also includes example shared memory 1610 that may be shared by the cores (e.g., Level 2 (L2 cache)) for high-speed access to data and/or instructions. Data and/or instructions may be transferred (e.g., shared) by writing to and/or reading from the shared memory 1610. The local memory 1620 of each of the cores 1602 and the shared memory 1610 may be part of a hierarchy of storage devices including multiple levels of cache memory and the main memory (e.g., the main memory 1514, 1516 of FIG. 15). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1602 may be referred to as a CPU, DSP, GPU, etc., or any other type of hardware circuitry. Each core 1602 includes control unit circuitry 1614, arithmetic and logic (AL) circuitry (sometimes referred to as an ALU) 1616, a plurality of registers 1618, the local memory 1620, and a second example bus 1622. Other structures may be present. For example, each core 1602 may include vector unit circuitry, single instruction multiple data (SIMD) unit circuitry, load/store unit (LSU) circuitry, branch/jump unit circuitry, floating-point unit (FPU) circuitry, etc. The control unit circuitry 1614 includes semiconductor-based circuits structured to control (e.g., coordinate) data movement within the corresponding core 1602. The AL circuitry 1616 includes semiconductor-based circuits structured to perform one or more mathematic and/or logic operations on the data within the corresponding core 1602. The AL circuitry 1616 of some examples performs integer based operations. In other examples, the AL circuitry 1616 also performs floating-point operations. In yet other examples, the AL circuitry 1616 may include first AL circuitry that performs integer-based operations and second AL circuitry that performs floating-point operations. In some examples, the AL circuitry 1616 may be referred to as an Arithmetic Logic Unit (ALU).

The registers 1618 are semiconductor-based structures to store data and/or instructions such as results of one or more of the operations performed by the AL circuitry 1616 of the corresponding core 1602. For example, the registers 1618 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1618 may be arranged in a bank as shown in FIG. 16. Alternatively, the registers 1618 may be organized in any other arrangement, format, or structure, such as by being distributed throughout the core 1602 to shorten access time. The second bus 1622 may be implemented by at least one of an I2C bus, a SPI bus, a PCI bus, or a PCIe bus.

Each core 1602 and/or, more generally, the microprocessor 1600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1600 is a semiconductor device fabricated to include many transistors interconnected to implement the structures described above in one or more integrated circuits (ICs) contained in one or more packages.

The microprocessor 1600 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1600, in the same chip package as the microprocessor 1600 and/or in one or more separate packages from the microprocessor 1600.

FIG. 17 is a block diagram of another example implementation of the programmable circuitry 1512 of FIG. 15. In this example, the programmable circuitry 1512 is implemented by FPGA circuitry 1700. For example, the FPGA circuitry 1700 may be implemented by an FPGA. The FPGA circuitry 1700 can be used, for example, to perform operations that could otherwise be performed by the example microprocessor 1600 of FIG. 16 executing corresponding machine readable instructions. However, once configured, the FPGA circuitry 1700 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1600 of FIG. 16 described above (which is a general purpose device that may be programmed to execute some or all of the machine readable instructions represented by the flowchart(s) of FIGS. 8-11 but whose interconnections and logic circuitry are fixed once fabricated), the FPGA circuitry 1700 of the example of FIG. 17 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 8-11. In particular, the FPGA circuitry 1700 may be thought of as an array of logic gates, interconnections, and switches. The switches can be programmed to change how the logic gates are interconnected by the interconnections, effectively forming one or more dedicated logic circuits (unless and until the FPGA circuitry 1700 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 8-11. As such, the FPGA circuitry 1700 may be configured and/or structured to effectively instantiate some or all of the operations/functions corresponding to the machine readable instructions of the flowchart(s) of FIGS. 8-11 as dedicated logic circuits to perform the operations/functions corresponding to those software instructions in a dedicated manner analogous to an ASIC. Therefore, the FPGA circuitry 1700 may perform the operations/functions corresponding to the some or all of the machine readable instructions of FIGS. 8-11 faster than the general-purpose microprocessor can execute the same.

In the example of FIG. 17, the FPGA circuitry 1700 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1700 of FIG. 17 may access and/or load the binary file to cause the FPGA circuitry 1700 of FIG. 17 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1700 of FIG. 17 to cause configuration and/or structuring of the FPGA circuitry 1700 of FIG. 17, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1700 of FIG. 17 may access and/or load the binary file to cause the FPGA circuitry 1700 of FIG. 17 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1700 of FIG. 17 to cause configuration and/or structuring of the FPGA circuitry 1700 of FIG. 17, or portion(s) thereof.

The FPGA circuitry 1700 of FIG. 17, includes example input/output (I/O) circuitry 1702 to obtain and/or output data to/from example configuration circuitry 1704 and/or external hardware 1706. For example, the configuration circuitry 1704 may be implemented by interface circuitry that may obtain a binary file, which may be implemented by a bit stream, data, and/or machine-readable instructions, to configure the FPGA circuitry 1700, or portion(s) thereof. In some such examples, the configuration circuitry 1704 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1706 may be implemented by external hardware circuitry. For example, the external hardware 1706 may be implemented by the microprocessor 1600 of FIG. 16.

The FPGA circuitry 1700 also includes an array of example logic gate circuitry 1708, a plurality of example configurable interconnections 1710, and example storage circuitry 1712. The logic gate circuitry 1708 and the configurable interconnections 1710 are configurable to instantiate one or more operations/functions that may correspond to at least some of the machine readable instructions of FIGS. 8-11 and/or other desired operations. The logic gate circuitry 1708 shown in FIG. 17 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1708 to enable configuration of the electrical structures and/or the logic gates to form circuits to perform desired operations/functions. The logic gate circuitry 1708 may include other electrical structures such as look-up tables (LUTs), registers (e.g., flip-flops or latches), multiplexers, etc.

The configurable interconnections 1710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1708 to program desired logic circuits.

The storage circuitry 1712 of the illustrated example is structured to store result(s) of the one or more of the operations performed by corresponding logic gates. The storage circuitry 1712 may be implemented by registers or the like. In the illustrated example, the storage circuitry 1712 is distributed amongst the logic gate circuitry 1708 to facilitate access and increase execution speed.

The example FPGA circuitry 1700 of FIG. 17 also includes example dedicated operations circuitry 1714. In this example, the dedicated operations circuitry 1714 includes special purpose circuitry 1716 that may be invoked to implement commonly used functions to avoid the need to program those functions in the field. Examples of such special purpose circuitry 1716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1700 may also include example general purpose programmable circuitry 1718 such as an example CPU 1720 and/or an example DSP 1722. Other general purpose programmable circuitry 1718 may additionally or alternatively be present such as a GPU, an XPU, etc., that can be programmed to perform other operations.

Although FIGS. 16 and 17 illustrate two example implementations of the programmable circuitry 1512 of FIG. 15, many other approaches are contemplated. For example, FPGA circuitry may include an on-board CPU, such as one or more of the example CPU 1720 of FIG. 16. Therefore, the programmable circuitry 1512 of FIG. 15 may additionally be implemented by combining at least the example microprocessor 1600 of FIG. 16 and the example FPGA circuitry 1700 of FIG. 17. In some such hybrid examples, one or more cores 1602 of FIG. 16 may execute a first portion of the machine readable instructions represented by the flowchart(s) of FIGS. 8-11 to perform first operation(s)/function(s), the FPGA circuitry 1700 of FIG. 17 may be configured and/or structured to perform second operation(s)/function(s) corresponding to a second portion of the machine readable instructions represented by the flowcharts of FIGS. 8-11, and/or an ASIC may be configured and/or structured to perform third operation(s)/function(s) corresponding to a third portion of the machine readable instructions represented by the flowcharts of FIGS. 8-11.

It should be understood that some or all of the circuitry of FIG. 1A may, thus, be instantiated at the same or different times. For example, same and/or different portion(s) of the microprocessor 1600 of FIG. 16 may be programmed to execute portion(s) of machine-readable instructions at the same and/or different times. In some examples, same and/or different portion(s) of the FPGA circuitry 1700 of FIG. 17 may be configured and/or structured to perform operations/functions corresponding to portion(s) of machine-readable instructions at the same and/or different times.

In some examples, some or all of the circuitry of FIG. 1A may be instantiated, for example, in one or more threads executing concurrently and/or in series. For example, the microprocessor 1600 of FIG. 16 may execute machine readable instructions in one or more threads executing concurrently and/or in series. In some examples, the FPGA circuitry 1700 of FIG. 17 may be configured and/or structured to carry out operations/functions concurrently and/or in series. Moreover, in some examples, some or all of the circuitry of FIG. 1A may be implemented within one or more virtual machines and/or containers executing on the microprocessor 1600 of FIG. 16.

In some examples, the programmable circuitry 1512 of FIG. 15 may be in one or more packages. For example, the microprocessor 1600 of FIG. 16 and/or the FPGA circuitry 1700 of FIG. 17 may be in one or more packages. In some examples, an XPU may be implemented by the programmable circuitry 1512 of FIG. 15, which may be in one or more packages. For example, the XPU may include a CPU (e.g., the microprocessor 1600 of FIG. 16, the CPU 1720 of FIG. 17, etc.) in one package, a DSP (e.g., the DSP 1722 of FIG. 17) in another package, a GPU in yet another package, and an FPGA (e.g., the FPGA circuitry 1700 of FIG. 17) in still yet another package.

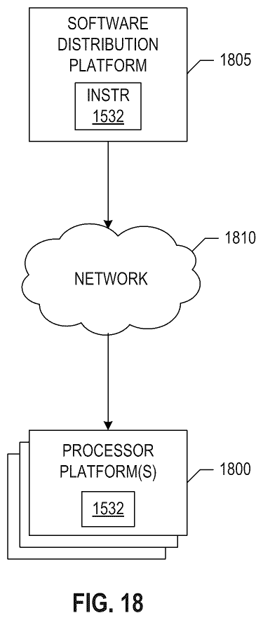

A block diagram illustrating an example software distribution platform 1805 to distribute software such as the example machine readable instructions 1532 of FIG. 15 to other hardware devices (e.g., hardware devices owned and/or operated by third parties from the owner and/or operator of the software distribution platform) is illustrated in FIG. 18. The example software distribution platform 1805 may be implemented by any computer server, data facility, cloud service, etc., capable of storing and transmitting software to other computing devices. The third parties may be customers of the entity owning and/or operating the software distribution platform 1805. For example, the entity that owns and/or operates the software distribution platform 1805 may be a developer, a seller, and/or a licensor of software such as the example machine readable instructions 1532 of FIG. 15. The third parties may be consumers, users, retailers, OEMs, etc., who purchase and/or license the software for use and/or re-sale and/or sub-licensing. In the illustrated example, the software distribution platform 1805 includes one or more servers and one or more storage devices. The storage devices store the machine readable instructions 1532, which may correspond to the example machine readable instructions of FIGS. 8-11, as described above. The one or more servers of the example software distribution platform 1805 are in communication with an example network 1810, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1532 from the software distribution platform 1805. For example, the software, which may correspond to the example machine readable instructions of FIG. 8-11, may be downloaded to the example programmable circuitry platform 1500, which is to execute the machine readable instructions 1532 to implement the controllable multimodal meeting summarization system 100. In some examples, one or more servers of the software distribution platform 1805 periodically offer, transmit, and/or force updates to the software (e.g., the example machine readable instructions 1532 of FIG. 15) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that perform real time note-taking and semantic entity extraction from multimodal inputs. The systems disclosed provide controllability, an expanded language model capacity, and adapt a language domain to learn better domain-specific terminology, all to produce more accurate domain-specific summaries. Disclosed systems, apparatus, articles of manufacture, and methods improve the efficiency of using a computing device by integrating language models to improve the accuracy of a computer as a summarization tool. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to summarize multimodal conferencing environments are disclosed herein. Further examples and combinations thereof include the following:

Example 1 includes an apparatus comprising interface circuitry, machine readable instructions, and programmable circuitry to at least one of instantiate or execute the machine readable instructions to adjust a language model based on a terminology utilized in a first context data, generate a conversation summary from a transcription and a human controlled variable, extract a semantic entity from the conversation summary and second context data, the second context data indicative of an input associated with a conferencing environment, and summarize the semantic entity and the second context data using the adjusted language model.

Example 2 includes the apparatus of example 1, wherein terminology with a common topic is extracted from the first context data to re-learn representations of the language model.

Example 3 includes the apparatus of example 1, wherein, to adjust the language model, the programmable circuitry is to create a copy of the first context data, add noise to the copy of the first context data, and retrain the language model using the first context data and the copy including the noise.

Example 4 includes the apparatus of example 1, wherein, to generate the conversation summary, the programmable circuitry is to embed sentences from the transcription into a model, run a clustering algorithm on the model to identify clusters, and find the sentences closest to a centroid of each cluster.

Example 5 includes the apparatus of example 4, wherein the human controlled variable is at least one of a window of time, a word to focus on, a phrase to focus on, or an entity to focus on.

Example 6 includes the apparatus of example 1, wherein, to generate the summary of the semantic entity and the second context data using the adjusted language model, the programmable circuitry is to collect transcriptions from a window of time of the conferencing environment, analyze the conferencing environment using the adjusted language model, the conversation summary, and the extracted semantic entity, and generate a summary of the conferencing environment using the analysis.

Example 7 includes the apparatus of example 1, wherein the programmable circuitry is to sample a visual sequence, encode the visual sequence and the transcription, and resample the encoded visual sequence.

Example 8 includes the apparatus of example 7, wherein the programmable circuitry is to sample the visual sequence via K-means clustering.

Example 9 includes the apparatus of example 7, wherein, to resample the encoded visual sequence, the programmable circuitry is to obtain a variable number of features from the encoded visual sequence and the encoded transcription, and select a representative fixed number of outputs.

Example 10 includes the apparatus of example 1, wherein the programmable circuitry is to retrieve a keyword or phrase, and pay particular attention to usage of the keyword or phrase when generating the conversation summary.

Example 11 includes a non-transitory computer readable medium comprising instructions that, when executed, cause a machine to at least adjust a language model based on a terminology utilized in a first context data, generate a conversation summary from a transcription and a human controlled variable, extract a semantic entity from the conversation summary and second context data, the second context data indicative of an input associated with a conferencing environment, and summarize the semantic entity and the second context data using the adjusted language model.

Example 12 includes the non-transitory computer readable medium of example 11, wherein terminology with a common topic is extracted from the first context data to re-learn representations of the language model.

Example 13 includes the non-transitory computer readable medium of example 11, wherein, to adjust the language model, the instructions are to create a copy of the first context data, add noise to the copy of the first context data, and retrain the language model using the first context data and the copy including the noise.

Example 14 includes the non-transitory computer readable medium of example 11, wherein, to generate the conversation summary, the instructions are to embed sentences from the transcription into a model, run a clustering algorithm on the model to identify clusters, and find the sentences closest to a centroid of each cluster.

Example 15 includes the non-transitory computer readable medium of example 14, wherein the human controlled variable is at least one of a window of time, a word to focus on, a phrase to focus on, or an entity to focus on.

Example 16 includes the non-transitory computer readable medium of example 11, wherein, to generate the summary of the semantic entity and the second context data using the adjusted language model, the instructions are to collect transcriptions from a window of time of the conferencing environment, analyze the conferencing environment using the adjusted language model, the conversation summary, and the extracted semantic entity, and generate a summary of the conferencing environment using the analysis.

Example 17 includes the non-transitory computer readable medium of example 11, wherein the instructions are to sample a visual sequence, encode the visual sequence and the transcription, and resample the encoded visual sequence.

Example 18 includes the non-transitory computer readable medium of example 17, wherein the instructions are to sample the visual sequence via K-means clustering.

Example 19 includes the non-transitory computer readable medium of example 17, wherein, to resample the encoded visual sequence, the instructions are to obtain a variable number of features from the encoded visual sequence and the encoded transcription, and select a representative fixed number of outputs.

Example 20 includes the non-transitory computer readable medium of example 11, wherein the instructions are to retrieve a keyword or phrase, and pay particular attention to usage of the keyword or phrase when generating the conversation summary. The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine readable instructions; and
programmable circuitry to at least one of instantiate or execute the machine readable instructions to:
adjust a language model based on a terminology utilized in a first context data;
generate a conversation summary from a transcription and a human controlled variable;
extract a semantic entity from the conversation summary and a second context data, the second context data indicative of an input associated with a conferencing environment; and
summarize the semantic entity and the second context data using the adjusted language model.

2. The apparatus of claim 1, wherein the terminology utilized in the first context data has a theme and is extracted from the first context data to re-learn representations of the language model.

3. The apparatus of claim 1, wherein, to adjust the language model, the programmable circuitry is to:
create a copy of the first context data;
add noise to the copy of the first context data; and
retrain the language model using the first context data and the copy of the first context data including the noise.

4. The apparatus of claim 1, wherein, to generate the conversation summary, the programmable circuitry is to:
embed sentences from the transcription into a model;
run a clustering algorithm on the model to identify clusters; and
find the sentences closest to a centroid of each cluster.

5. The apparatus of claim 1, wherein the human controlled variable is at least one of a window of time, a word to focus on, a phrase to focus on, or an entity to focus on.

6. The apparatus of claim 1, wherein, to generate the summary of the semantic entity and the second context data using the adjusted language model, the programmable circuitry is to:
collect transcriptions from a window of time of the conferencing environment;
analyze the conferencing environment using the adjusted language model, the conversation summary, and the extracted semantic entity; and
generate a summary of the conferencing environment using the analysis.

7. The apparatus of claim 1, wherein the programmable circuitry is to:
sample a visual sequence associated with the conferencing environment;
encode the visual sequence and the transcription; and
resample the encoded visual sequence.

8. The apparatus of claim 7, wherein the programmable circuitry is to sample the visual sequence via K-means clustering.

9. The apparatus of claim 7, wherein, to resample the encoded visual sequence, the programmable circuitry is to:
obtain a variable number of features from the encoded visual sequence and the encoded transcription; and
select a representative fixed number of frames as outputs.

10. The apparatus of claim 1, wherein the programmable circuitry is to:
retrieve a keyword or phrase from an input; and
monitor usage of the retrieved keyword or phrase when generating the conversation summary.

11. A non-transitory computer readable medium comprising instructions that, when executed, cause a machine to at least:
adjust a language model based on a terminology utilized in a first context data;
generate a conversation summary from a transcription and a human controlled variable;
extract a semantic entity from the conversation summary and second context data, the second context data indicative of an input associated with a conferencing environment; and
summarize the semantic entity and the second context data using the adjusted language model.

12. The non-transitory computer readable medium of claim 11, wherein the terminology utilized in the first context data has a theme and is extracted from the first context data to re-learn representations of the language model.

13. The non-transitory computer readable medium of claim 11, wherein, to adjust the language model, the instructions are to:
create a copy of the first context data;
add noise to the copy of the first context data; and
retrain the language model using the first context data and the copy of the first context data including the noise.

14. The non-transitory computer readable medium of claim 11, wherein, to generate the conversation summary, the instructions are to:
embed sentences from the transcription into a model;
run a clustering algorithm on the model to identify clusters; and
find the sentences closest to a centroid of each cluster.

15. The non-transitory computer readable medium of claim 11, wherein the human controlled variable is at least one of a window of time, a word to focus on, a phrase to focus on, or an entity to focus on.

16. The non-transitory computer readable medium of claim 11, wherein, to generate the summary of the semantic entity and the second context data using the adjusted language model, the instructions are to:
collect transcriptions from a window of time of the conferencing environment;
analyze the conferencing environment using the adjusted language model, the conversation summary, and the extracted semantic entity; and
generate a summary of the conferencing environment using the analysis.

17. The non-transitory computer readable medium of claim 11, wherein the instructions are to:
sample a visual sequence associated with the conferencing environment;
encode the visual sequence and the transcription; and
resample the encoded visual sequence.

18. The non-transitory computer readable medium of claim 17, wherein the instructions are to sample the visual sequence via K-means clustering.

19. The non-transitory computer readable medium of claim 17, wherein, to resample the encoded visual sequence, the instructions are to:
obtain a variable number of features from the encoded visual sequence and the encoded transcription; and
select a representative fixed number of frames as outputs.

20. The non-transitory computer readable medium of claim 11, wherein the instructions are to:
Retrieve a keyword or phrase from an input; and
monitor usage of the retrieved keyword or phrase when generating the conversation summary.
